(19) United States
(12) Patent Application Publication
(10) Pub. No.: US 2009/0063717 A1
(43) Pub. Date: Mar. 5, 2009

(54) Rate Adaptation for Support of Full-Speed USB Transactions Over a High-Speed USB Interface

(76) Inventors: Mark R. Bohm, Village of Bear Creek, TX (US); Morgan H. Monks, Tempe, AZ (US); Henry Wurzburg, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/846,066

(22) Filed: Aug. 28, 2007

(51) Int. Cl. G06F 3/00

(52) U.S. Cl. 710/8

(57) ABSTRACT

A USB communications interface (USBCI) may enable communication between a high-speed USB device, e.g. a High-Speed-Inter-Chip (HSIC) USB device, and a non high-speed USB host, e.g. a full-speed USB host. The USBCI may receive first data from the USB host via a non high-speed transaction, and buffer the first data. The USBCI may also initiate a high-speed transaction corresponding to the non high-speed transaction to the USB device, and transmit at least a portion of the buffered first data to the USB device via the high-speed transaction. The USBCI may subsequently receive second data from the USB device via the high-speed transaction, and buffer the second data. The USBCI may also transmit at least a portion of the buffered second data to the USB host via the non high-speed transaction, and complete the non high-speed transaction upon the high-speed transaction completing.

### BACKGROUND OF THE INVENTION

1. Field of the Invention

The present invention relates generally to digital device interfaces, such as a USB interface, and more specifically to rate adaptation for support of full-speed USB transactions over a high-speed USB interface.

2. Description of the Related Art

The Universal Serial Bus (USB) allows coupling of peripheral devices to a computer system. USB is a serial cable bus for data exchange between a host computer and a wide range of simultaneously accessible devices. The bus allows peripherals to be attached, configured, used, and detached while the host is in operation. For example, USB printers, scanners, digital cameras, storage devices, card readers, etc. may communicate with a host computer system over USB. USB based systems may require that a USB host controller be present in the host system, and that the operating system (OS) of the host system support USB.

USB devices may communicate over the USB bus at low-speed (LS), full-speed (FS), or high-speed (HS), HS being the highest speed. A connection between the USB device and the host may be established via digital interconnect such as Inter-Chip USB, ULPI, UTMI, etc., or via a four wire interface that includes a power line, a ground line, and a pair of data lines D+ and D−. When a USB device connects to the host, the USB device may first pull a D+ line high (the D− line if the device is a low speed device) using a pull up resistor on the D+ line. The host may respond by resetting the USB device. If the USB device is a high-speed USB device, the USB device may “chirp” by driving the D− line high during the reset. The host may respond to the “chirp” by alternately driving the D+ and D− lines high. The USB device may then electronically remove the pull up resistor and continue communicating at high speed. When disconnecting, full-speed devices may remove the pull up resistor from the D+ line (i.e., “tri-state” the line), while high-speed USB devices may tri-state both the D+ and D− lines.

Embedded products, as well as portable devices, such as cell phones, personal digital assistants (PDAs), and MP3 players are often implemented with a USB interface because of their popularity, driver support, interoperability and relative low cost of USB devices. However, standard USB devices include an analog physical layer (PHY) component, along with pull-up and pull-down resistors that constantly consume power (even when in suspend or standby). These aspects of USB make it less attractive to power conscious embedded devices, particularly those operating from a battery. It has therefore become desirable to provide USB connectivity, without the added power consumption of analog PHYs and pull-up and pull-down resistors.

The USB-IF (USB Implementers Forum) created and released an Inter-Chip 1.0 specification, addressing some of the analog PHY issues of USB, and is therefore more attractive for portable devices, but the interface is not capable of HS (high speed) USB transfer speeds, and retains the differential data (D+/D−) aspect of USB, which typically requires eye diagrams, clock recovery and synchronization. The USB High-Speed-Inter-Chip (HSIC) specification enables a digital chip-to-chip interconnect mechanism to support USB as a circuit board bus. However, HSIC doesn't directly support USB full-speed or USB low-speed operation, and the HSIC specification suggests that USB hubs be used to support off circuit board connectivity from HSIC hosts. In other words, connection of HSIC devices to external USB hosts is not supported and/or anticipated by the HSIC standard.

While not all products can conveniently support a USB hub (or in some cases may decide against supporting USB hubs due to cost and/or power considerations), those same products may desire connectivity to external traditional USB hosts (high-speed or full-speed). As mentioned above, the USB specifications recommend the use of a USB hub for connectivity from a full-speed/high-speed host to low-speed/full-speed/high-speed devices. Currently, there are no known solutions for connectivity from a high-speed operating device to a full-speed host, as USB hubs provide connectivity from a High-Speed Host to devices of any legal USB speed.

USB hubs typically provide one-to-many, or many-to-one connectivity between a host and one or more peripheral devices. In most situations, this connectivity may prove very effective, but it may fail to meet the needs of the ultra-mobile marketplace for at least a number of reasons. These reasons include the need by mobile products for one-to-one connectivity (the “many-to-one” and “one-to-many” connectivity provided by hubs is not a need and/or advantage for this marketplace), the absence of support by hubs for USB OTG (on the go) dual role capability, the physically larger size and power consumption of hubs compared to a typical PHY (which provides one-to-one connectivity in traditional USB), and the fact that hubs do not enable for high-speed device connectivity to a full-speed host.

Other corresponding issues related to the prior art will become apparent to one skilled in the art after comparing such prior art with the present invention as described herein.

### SUMMARY OF THE INVENTION

Various embodiments of the present invention may comprise a mechanism for USB rate adaptation to provide direct one-to-one (i.e. hubless) USB connectivity between high-speed USB devices, such as HSIC (High Speed Inter-Chip) enabled USB peripherals, and external traditional USB hosts. Various embodiments of the present invention may also provide USB connectivity between high-speed USB devices and USB Inter-Chip embedded full-speed hosts. In specific instances, USB devices configured according to various embodiments of the present invention may be high-speed, HSIC enabled USB peripheral devices that may be attached to any one of high-speed USB hosts, full-speed USB hosts, and/or USB Inter-Chip hosts, giving those peripheral devices increased versatility, adaptability, and portability.

In addition to comprising all required elements of an HSIC interface and a standard USB analog PHY interface, embodiments of the present invention may also include a full-speed to high-speed rate adapter (and complementarily, a high-speed to full-speed rate adapter), and a buffer mechanism to store packets transmitted by one interface (full-speed or high-speed) prior to delivery to the other interface (high-speed or full-speed, respectively). A mechanism to perform USB attach and chirp functions on the USB PHY interface may also be included to ensure proper speed negotiation with high-speed host controllers. Operationally, when the HSIC enabled peripheral is connected to an external high-speed host, no rate adaptation may be necessary, but when the HSIC enabled peripheral is connected to a full-speed host, rate adaptation may be performed.

In one set of embodiments, performing rate adaptation may include the USB PHY interface receiving packets transmitted as part of a full-speed transaction, buffering the received packets, and initiating a high-speed transaction on the HSIC interface in response to recognizing the full-speed transaction. Any data packets received via the high-speed transaction may also be buffered, and once the high-speed transaction has completed, a corresponding full-speed data transfer to the USB host may take place, and the full-speed transaction may then be completed. In addition, in-band or side band signaling may be performed to ensure that the high-speed HSIC peripheral responds with correct descriptors to the external full-speed host (which is not high-speed capable).

In one set of embodiments, a USB communications interface (USBCI) may be configured to manage communications between a high-speed USB device, e.g. a High-Speed-Inter-Chip (HSIC) USB device, and a non high-speed USB host, e.g. a full-speed USB host. The USBCI may receive data packets from the USB host via a non high-speed transaction, parse the received data packets to retrieve pertinent first data, and buffer the pertinent first data. The USBCI may also initiate a high-speed transaction to the USB device, where the high-speed transaction corresponds to the non high-speed transaction, and transmit at least a portion of the buffered pertinent first data to the USB device via the high-speed transaction. The USBCI may subsequently receive data packets from the USB device via the high-speed transaction, parse the received data packets to retrieve pertinent second data, and buffer the pertinent second data. The USBCI may transmit at least a portion of the buffered pertinent second data to the USB host via the non high-speed transaction, and complete the non high-speed transaction upon the high-speed transaction completing.

### BRIEF DESCRIPTION OF THE DRAWINGS

A better understanding of the present invention may be obtained when the following detailed description is considered in conjunction with the following drawings, in which:

FIG. 1 is a block diagram showing a USB communications interface configured to couple a USB HSIC (High-Speed-Inter-Chip) device to a full-speed USB host, according to one embodiment;

FIG. 2 is a block diagram showing a USB communications interface configured to couple a USB HSIC device to an Inter-Chip (full-speed) USB host, according to one embodiment;

FIG. 3 is a block diagram showing a USB communications interface configured to provide a variety of possible connections between USB hosts and USB devices of various speeds, including coupling a USB HSIC peripheral device to a full-speed USB host; and

FIG. 4 shows a block diagram of one possible implementation of the USB communications interface shown in FIG. 3.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (e.g., having the potential to or being able to in some embodiments), not a mandatory sense (i.e., must). The term “include”, and derivations thereof, mean “including, but not limited to”. The term “coupled” means “directly or indirectly connected”.

### DETAILED DESCRIPTION OF THE PREFERRED EMBODIMENTS

The USB standard generally supports three data rates. The lowest data rate is usually referred to as low-speed (USB 1.1), and corresponds to a rate of 1.5 Mbps (1.5 megabits per second, or 192 KBps; kilobytes per second), and is typically used for Human Interface Devices (HID) such as keyboards, mice, and joysticks. The next higher data rate is usually referred to as full-speed (USB 1.1), and corresponds to rate of 12 Mbps (or 1.5 MBps; megabytes per second). Before the introduction of the USB 2.0 specification, full-speed was the fastest available USB data rate, and many devices/hosts still operate at full-speed, typically dividing the USB bandwidth between them in a first-come first-served basis. It is thus not uncommon for the overall bandwidth to become insufficient when several isochronous devices are coupled to the USB bus. In general, all USB hubs support full-speed operation. As of the present day, the current highest USB data rate is referred to as high-speed (USB 2.0), and corresponds to a rate of 480 Mbps (or 60 MBps).

Although high-Speed devices are generally referred to as “USB 2.0” and are advertised as having speeds of “up to 480 Mbps”, not all USB 2.0 devices are actually capable of operating at that speed. The actual throughput currently attained with most actual USB devices is about half of the full theoretical 60 Mbps data rate. Many high-speed USB devices typically operate at slower speeds, often at about 3 MBps overall, sometimes up to 10-20 MBps. In addition, various other USB related standards, e.g. WHCI (wireless host control interface) and Wireless USB specify operating speeds considered to be intermediate speeds, e.g. 120 Mbps.

As previously mentioned, the USB-IF HSIC Specification essentially provides a digital chip-to-chip interconnect mechanism that supports USB as a circuit board bus, but doesn't directly support USB full-speed or USB low-speed operation. The HSIC specification further suggests connecting HSIC USB devices to traditional USB hosts or peripheral devices that are configured off the circuit board through USB hubs, using USB cables and connectors. However, not all products may be able to conveniently support a USB hub (due to cost and/or power considerations, for example), while still seeking to attain connectivity to external traditional USB hosts (high-speed or full-speed). Various embodiments of the present invention provide high-speed USB devices with connectivity to traditional high-speed/full-speed (or intermediate speed) USB hosts without requiring a USB hub when coupling the high-speed device to a non high-speed, (referred to herein as any speed that is not high-speed, e.g. lower than 480 Mbps for USB 2.0), USB host.

In addition to the straightforward required elements of an HSIC interface and a standard USB analog PHY (physical) interface, various embodiments of a USB communications interface (USBCI) may also include a full-speed to high-speed rate adapter and a buffer mechanism to store packets received from one interface prior to their delivery to the other interface. A mechanism to perform USB “attach” and “chirp” functions on the USB PHY interface may also be included to ensure proper speed negotiation when communicating with high-speed USB host controllers.

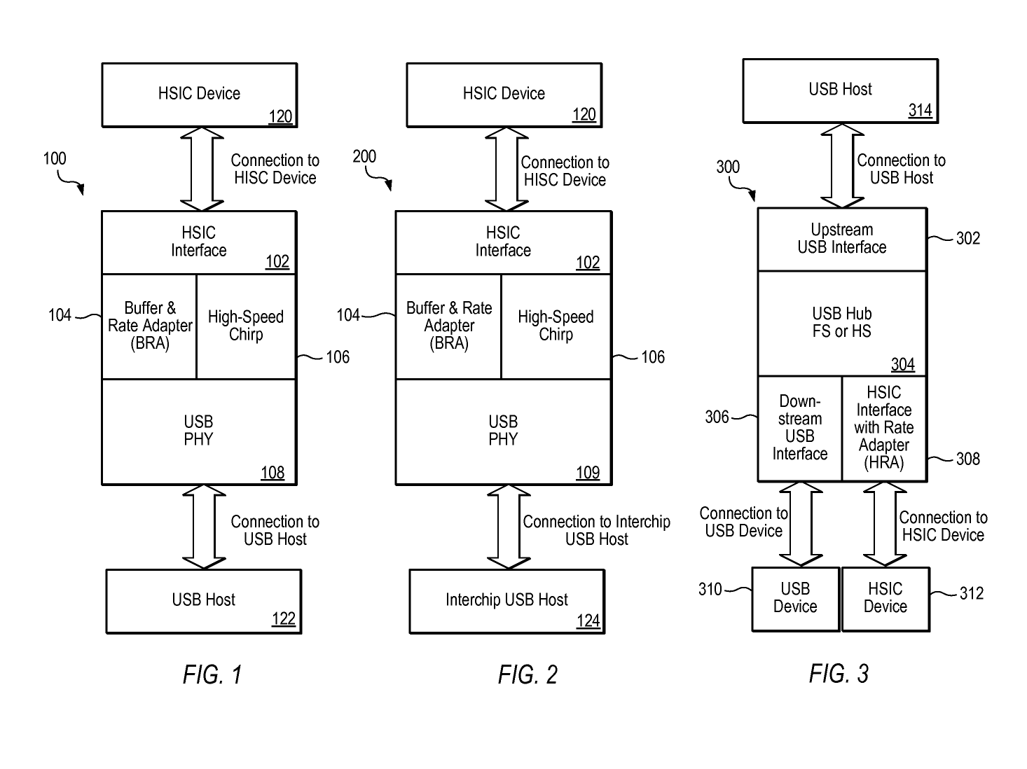

FIG. 1 shows one embodiment of a USBCI 100 that is configured to couple a high-speed device, e.g. an HSIC USB device 120, to a USB host 122, which may be a non high-speed, e.g. full-speed USB host. Packets received from USB host 122 by USB PHY interface 108 via a non high-speed transaction may be buffered by Buffer and Rate Adapter (BRA) 104. BRA 104 may initiate a high-speed transaction on HSIC interface 102 to transmit the buffered packets to HSIC USB device 120 via the high-speed transaction. Packets received from HSIC USB device 120 via the high-speed transaction may also be buffered by BRA 104, which may then send those buffered packets to USB host 122 via the non high-speed transaction. Once the high-speed transaction completes, BRA 104 may complete the non high-speed transaction.

The packets received from USB host 122 may be of many different types that include but are not limited to SOF (start of frame) packets, Data packets, IN packets, OUT packets, Setup packets, Handshake packets, and Preamble packets. In case of Data packets, for example, each packet may comprise multiple frames that may include (without being limited to) a sync frame, type frame, check frame, data, CRC frame, and EOP (end of packet) frame. In some embodiments, when receiving Data packets, for example, BRA 104 may be configured to initiate the corresponding high-speed transaction on HSIC interface 102 while still buffering the data, before having received the CRC frame and the EOP frame. In other embodiments, the entire Data packet may be buffered before the corresponding high-speed transaction is initiated. In general, the high-speed transaction may be initiated at any selected time after a first portion of a packet has been received from USB host 122. Various possibilities and embodiments are possible, and a determination of when the high-speed transaction is to be initiated may be made according to various criteria, e.g. the size of the data and/or overall size of the Data packet, and other considerations as required. Those skilled in the art will appreciate that initiating the high-speed transaction may be performed according to requirements and considerations pertaining to the system in which USBCI 100 is configured.

In some embodiments, BRA 104 may also be configured to transmit a response to USB host 122 in response to having received an acknowledgement from USB host 122. While BRA 104 may be configured to always respond to acknowledgments in this manner, in some embodiments BRA 104 may be configured to respond to acknowledgements received from USB host 122 only when a response timer of HSIC USB device 120 expires prior to the acknowledgement being received from USB host 122. For example, if the packet size of each of the data packets received from USB host 122 exceeds a specified size, the response timer of HSIC USB device 120, which would be operating according to high-speed specifications, may expire before acknowledgement is received from USB host 122, which would be operating according to non high-speed, e.g. full-speed specifications. Thus, BRA 104 may also be configured to perform device snooping during USB enumeration to obtain a respective address that identifies HSIC USB device 120, in order to properly indicate to USB host 122, when BRA 104 is transmitting the response, that the response is from the respective address identifying HSIC USB device 120.

FIG. 2 shows one embodiment of a USBCI 200 that is configured to couple a high-speed device, e.g. an HSIC USB device 120, to an Inter-Chip USB host 124. USB Inter-Chip host 124 may be a full-speed host without a full-speed transceiver. Thus, the connections from USB PHY 109 to USB Inter-Chip host 124 may be using signaling levels which are different from the signaling levels used by the connections from USB PHY 108 to conventional USB full-speed host 122 (in FIG. 1). Packets received from Inter-Chip USB host 124 by USB PHY interface 109 via a non high-speed transaction may again be buffered by Buffer and Rate Adapter (BRA) 104. BRA 104 may again initiate a high-speed transaction on HSIC interface 102 to transmit the buffered packets to HSIC USB device 120 via the high-speed transaction. Packets received from HSIC device 120 via the high-speed transaction may also be buffered by BRA 104, which may then send those buffered packets to Inter-Chip USB host 124 via the non high-speed transaction. Once the high-speed transaction completes, BRA 104 may again complete the non high-speed transaction.

It should be noted also that both USBCI 100 and USBCI 200 may include High-Speed Chirp functionality 106, to provide a mechanism to perform USB “attach” and “chirp” functions on USB PHY interface 108 and 109, respectively, to ensure proper speed negotiation with USB host 122 and Inter-Chip USB host 124, respectively, when USB host 122 and Inter-Chip USB host 124 respectively comprise high-speed USB host controllers. USBCI 100 and 200 may therefore be used to couple HSIC USB device 120 to high-speed or non high-speed USB hosts. Operationally, if USB hosts 122 and 124 are high-speed hosts, no rate adaptation may be necessary and BRA 104 may not need to be operated. However, when USB hosts 122 and 124 are a non high-speed host, e.g. a full-speed hosts, then rate adaptation may be required, and BRA 104 may be used/operated.

As previously mentioned, when USB Inter-Chip host 124 is a full-speed host without a full-speed transceiver, the connections from USB PHY 109 to USB Inter-Chip host 124 may be using signaling levels which are different from the signaling levels used by the connections from USB PHY 108 to conventional USB full-speed host 122 (in FIG. 1). FIG. 3 shows one embodiment of a USBCI 300, which is implemented to operate with any of the voltage classes specified in the USB Inter-Chip specification, as well as the signaling of a conventional full-speed USB Host. In addition, added hub functionality may enable USBCI 300 to operate in either device mode or hub mode. In this embodiment, an upstream USB interface 302 may connect to a USB host of any speed, and circuitry 304 may provide full-speed and/or high-speed USB hub functionality. A downstream USB Interface 306 may provide connectivity to a standard USB device 310, while HSIC interface 308 may provide connectivity to an HSIC USB device 312. HSIC interface 308 may also provide rate adaptation to allow HSIC device 312 to operate with USB host 314, even if USB host 314 is a non high-speed host, e.g. a full-speed host.

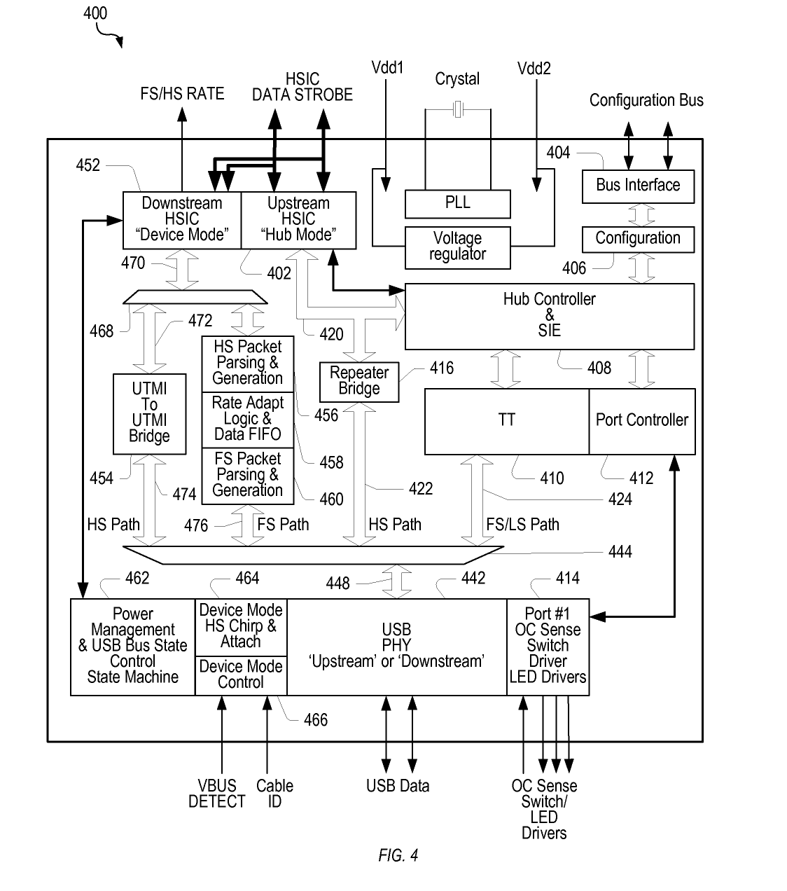

FIG. 4 shows one possible embodiment 400 of USBCI 300 from FIG. 3. In this embodiment, USBCI 400 includes circuitry to provide a variety of configurations for coupling USB devices and hosts. USBCI 400 may be implemented as an integrated circuit that may be part of a USB host or a USB device. For example, when USBCI 400 is part of a USB host, the USB hub functionality allows the host to couple to external analog USB devices. In other words, the host comprising USBCI 400 may operate in hub mode. When USBCI 400 is part of a USB device, the USB device may couple to an external analog USB host. In other words, the device comprising USBCI 400 may operate in device mode. In addition, USBCI 400 may include rate adaptation circuitry, such that when operating in device mode, USBCI 400 may enable an HSIC device to communicate with a USB host that is operating at non high-speed. Hub functionality is supported by bus interface 404, which may interface with a configuration bus (e.g. serial bus, parallel bus, any one or more proprietary buses, etc.) comprised in the system, configuration logic 406, upstream interface 402, repeater bridge 416, hub controller 408, transaction translator (TT) 410, port controller 412, and port 414. Upstream port 402, repeater bridge 416, and hub controller 408 may be coupled to each other via a UTMI (USB Transceiver Macrocell Interface) connection 420. TT 410 and repeater bridge 416 may be coupled to multiplexer 444 via UTMI connections 422 and 424, respectively, to access USB PHY interface 442. When operating in hub mode, communication may take place between a USB device coupled to USB PHY interface 442 and a USB host coupled to upstream interface 402.

Device mode functionality for coupling USB devices, including HSIC devices to any speed hub is supported by downstream interface 452, UTMI to UTMI bridge 454, high-speed packet parsing and generation block 456, rate adaptation logic and data queue block 458, and non high-speed (full-speed in the embodiment shown) packet parsing and generation block 460. When no rate adaptation is necessary, data movement may take place via bridge 454, the path being selected via multiplexer 468, which may couple downstream interface 452 to bridge 454 via UTMI connections 470 and 472, respectively. Access to USB PHY 442 may be provided from bridge 454 and packet parsing block 460 through multiplexer 444 via respective UTMI connections 474, 476 and 448. When coupling an HSIC device to a non high-speed host, the data path is through packet parsing blocks 456 and 458, and rate adaptation logic and queue block 458.

In one set of embodiments, an HSIC device may be coupled to downstream port 452, and a non high-speed USB host may be coupled to USB PHY interface 442. Device mode control block 466 may determine based on the Cable ID signal that USBCI 400 is to operate in device mode. Device mode attach block 464 and bus control block 462 may ensure proper device mode operation. Packets sent from the attached USB host as part of a non high-speed transaction may be intercepted by packet parsing block 460, via USB PHY interface 442 and multiplexer 44, and may be buffered in a data FIFO comprised in block 458. The packets may be parsed to generate packets for a high-speed transaction corresponding to the non high-speed transaction. Rate adaptation logic also comprised in block 458 (hereafter referred to as RAL 458) may initiate the high-speed transaction corresponding to the non high-speed transaction on downstream interface 452, and transmit the generated packets through downstream interface 452 to the attached HSIC device. Packets sent from the attached HSIC device as part of the high-speed transaction may be intercepted by packet parsing block 456, and may be buffered in the data FIFO comprised in block 458. The packets may again be parsed, this time to generate packets for the non high-speed transaction initially initiated by the attached USB host. RAL 458 may transmit the generated packets through downstream interface 452 to the attached HSIC device as part of the non high-speed transaction, and complete the non high-speed transaction once the high-speed transaction has completed.

Similar to the functionality of module 104 in FIGS. 1 and 2 (and module 308 in FIG. 3), RAL 458 may also be configured to transmit a response to the USB host attached to USB PHY 442 in response to having received an acknowledgement (hereafter referred to as ACK) from the attached USB host. In one set of embodiments, responses to ACKs received from the USB host may be transmitted to the USB host by RAL 458, when a response timer of the HSIC USB device coupled to interface 452 expires prior to the ACK having been received from the USB host. Again, if the packet size of each of the data packets received from the USB host exceeds a specified size, the response timer of the HSIC USB device operating according to high-speed specifications may expire before ACK is received from the USB host.

In addition, RAL 458 may also be configured to appropriately handle and/or accommodate a variety of different signal handshaking configurations and/or requirements. For example, in addition to responding to an ACK received from the USB host (when the ACK is received earlier than expected by the HSIC device), RAL 458 may also operate to transmit that ACK signal (or an ACK signal corresponding to the received ACK signal) to the HSIC device. In this manner, proper communication and data transfer may be maintained between the HSIC device and the USB host. Furthermore, RAL 458 may also be adapted to transmit an ACK to the USB host, in case an ACK expected by the USB host (according to the USB specification) has not yet been generated and/or issued by the HSIC device within an expected time period. This may occur, for example, when buffering of the data in the queue comprised in block 458 results in a delay in the generation of certain handshaking signals, such as ACK signals generated by the USB host and/or HSIC device.

In general, RAL 458 may be configured to issue handshaking signals corresponding to handshaking signals generated by the USB host and/or HSIC device at earlier than expected times, where the time shift may possibly be the result of a time delay incurred while buffering the data in the queue comprised in block 458. For example, when a maximum device packet size cannot be controlled, USBCI 400 may still be in the process of buffering data received from the USB host at a time when the USB host expects an ACK. RAL 458 may be configured to transmit an ACK to the USB host in such a case to insure proper communication between the HSIC device and the USB host. RAL 458 may further be configured to respond and/or ignore a subsequent (corresponding) ACK issued by the HSIC device, since RAL 458 may already have transmitted the required ACK signal to the USB host. RAL 458 may further be configured to similarly issue a handshaking signal, e.g. ACK, to the HSIC device when a corresponding expected handshaking signal, e.g. ACK signal, is not received in time from the USB host.

In one set of embodiments, USBCI 400 may be configured to implement a chirping feature to establish a proper operating relationship between a high-speed device, e.g. an HSIC device, and a non high-speed host, e.g. an FS USB host. Thus, upon coupling a high-speed device to interface 452 and a non high-speed host to USB PHY 442, Power Management & USB Bus State Control State Machine 462 may operate to indicate to the high-speed device via the FS/HS Rate signal from interface 452, that the attached host is a non high-speed host, thereby making the high-speed device aware of the expected speed of the host with which the device will be communicating.

It should be noted that while various embodiments described herein feature HSIC USB devices, they are provided as examples of high-speed USB devices, and are meant to be interpreted in that manner. Various other embodiments are not limited to HSIC devices and may feature other types of USB devices operating at higher speeds than the USB host(s) with which those devices are meant to communicate. Furthermore, while some functionality has only been described with respect to FIG. 4, at least the same functionality may also apply to the embodiments of the corresponding circuits and/or blocks in FIGS. 1, 2, and 3.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

We claim:

1. A USB communications interface comprising:
a first interface configured to send and/or receive data to and/or from a USB host;
a second interface configured to send and/or receive data to and/or from a USB device; and
an adapter coupled between the first interface and the second interface, wherein the adapter is configured to:
buffer data received by the first interface via a non high-speed transaction;
initiate on the second interface a high-speed transaction corresponding to the non high-speed transaction;
buffer data received by the second interface via the high-speed transaction; and
complete the non high-speed transaction upon completion of the high-speed transaction.

2. The USB communications interface of claim 1, wherein the second interface is further configured to transmit the buffered data received by the first interface to the USB device via the high-speed transaction.

3. The USB communications interface of claim 1, wherein the first interface is further configured to transmit to the USB host via the non high-speed transaction the buffered data received by the second interface.

4. The USB communications interface of claim 1, wherein the second interface is a USB High-Speed Inter-Chip (HSIC) interface, and wherein the first interface is a physical layer (PHY) interface to one of:
a USB host; or
an Inter-Chip USB host.

5. The USB communications interface of claim 1, wherein the USB communications interface is comprised on an integrated circuit.

6. The USB communications interface of claim 1 further comprising:
USB hub circuitry coupled between the first interface and the second interface, wherein the USB hub circuitry is configured to operate the USB communications interface as a USB hub, to enable the first interface to send and/or receive data to and/or from a USB device, and to enable the second interface to send and/or receive data to and/or from a USB host.

7. The USB communications interface of claim 1, wherein the adapter comprises:
first circuitry coupled to the first interface and configured to parse the data received by the first interface via the non high-speed transaction;
second circuitry coupled to the second interface and configured to parse the data received by the second interface via the high-speed transaction; and
a first-in-first-out (FIFO) buffer coupled between the first circuitry and the second circuitry, and configured to store the parsed data received by the first interface via the non high-speed transaction and/or store the parsed data received by the second interface via the high-speed transaction.

8. The USB communications interface of claim 7, wherein the first interface is configured to receive the data from the USB host in packets, and the second interface is configured to receive the data from the USB device in packets;
wherein the first circuitry is configured to parse the packets received by the first interface via the non high-speed transaction, and the second circuitry is configured to parse the packets received by the second interface via the high-speed transaction; and
wherein the FIFO buffer is configured to store the parsed packets received by the first interface via the non high-speed transaction, and/or store the parsed packets received by the second interface via the high-speed transaction.

9. The USB communications interface of claim 8;
wherein the first circuitry is configured to generate first packets from the stored parsed packets received by the second interface via the high-speed transaction, wherein the first interface is configured transmit the first packets to the USB host via the non high-speed transaction; and/or
wherein the second circuitry is configured to generate second packets from the stored parsed packets received by the first interface via the non high-speed transaction, wherein the second interface is configured transmit the second packets to the USB device via the high-speed transaction.

10. A method for a USB device communicating with a USB host, the method comprising:
receiving first data from the USB host via a first transaction, wherein the first transaction is a non high-speed transaction;
initiating a second transaction corresponding to the first transaction in response to said receiving the first data, wherein the second transaction is a high-speed transaction directed to the USB device; and
completing the first transaction in response to the second transaction completing.

11. The method of claim 10, further comprising performing one or more of:
buffering at least a first portion of the first data prior to said initiating the second transaction;
when said buffering the at least first portion of the first data is performed, transmitting at least a portion of the buffered at least first portion of the first data to the USB device via the second transaction;
receiving second data from the USB device via the second transaction, and buffering at least a first portion of the second data; or
when said receiving the second data and said buffering the at least first portion of the second data are performed, transmitting at least a portion of the buffered at least first portion second data to the USB host via the first transaction.

12. The method of claim 10, wherein said receiving the first data comprises receiving first data packets comprising the first data, the method further comprising one or more of:
parsing the first data packets to retrieve at least a first portion of the first data, and buffering the at least first portion of the first data; and
when said parsing the first data packets and said buffering the at least first portion of the first data are performed, transmitting the buffered at least first portion of the first data to the USB device via the second transaction.

13. The method of claim 10, further comprising performing one of:
receiving an acknowledgement from the USB host via the first transaction, and transmitting a response to the USB host via the first transaction in response to said receiving the acknowledgement; or
receiving an acknowledgement from the USB host via the first transaction, transmitting a response to the USB host via the first transaction in response to said receiving the acknowledgement, and transmitting the acknowledgement to the USB device via the second transaction.

14. The method of claim 13, wherein said transmitting the response to the USB host is performed when a response timer of the USB device expires prior to said receiving the acknowledgement from the USB host.

15. The method of claim 14, wherein said receiving the first data comprises receiving the first data in data packets, and wherein the response timer of the USB device expires prior to said receiving the acknowledgement from the USB host as a result of a size of at least one of the data packets exceeding a specified size.

16. The method of claim 13, further comprising snooping devices during enumeration to obtain a respective address identifying the USB device, wherein said transmitting the response to the USB host comprises indicating to the USB host that the response is from the respective address identifying the USB device.

17. The method of claim 10, further comprising transmitting a first acknowledgement to the USB host via the first transaction, wherein the first acknowledgement corresponds to a second acknowledgement expected from the USB device by the USB host in response to said receiving the first data.

18. The method of claim 17, further comprising buffering the first data prior to said initiating the second transaction, wherein said transmitting the first acknowledgement to the USB host is performed when due to a time delay incurred as a result of said buffering, the second acknowledgement is not issued by the USB device via the second transaction by a time the second acknowledgement is expected by the USB host.

19. The method of claim 10, further comprising performing one of:
receiving an acknowledgement from the USB device via the second transaction, and transmitting a response to the USB device via the second transaction in response to said receiving the acknowledgement; or
receiving an acknowledgement from the USB device via the second transaction, transmitting a response to the USB device via the second transaction in response to said receiving the acknowledgement, and transmitting the acknowledgement to the USB host via the first transaction.

20. The method of claim 10, further comprising;
receiving data packets from the USB device via the second transaction, wherein the data packets comprise second data;
parsing the data packets to retrieve at least a first portion of the second data;
buffering the at least first portion of the second data; and
transmitting the buffered at least first portion of the second data to the USB host via the first transaction.

21. A system comprising:
a high-speed USB device;
a non high-speed USB host; and
a USB communications interface (USBCI) coupled between the USB device and the USB host, wherein the USBCI is configured to:
send and/or receive data to and/or from the USB host via a non high-speed transaction;
initiate a high-speed transaction to the USB device in response to receiving the data from the USB host, wherein the high-speed transaction corresponds to the non high-speed transaction; and
complete the non high-speed transaction in response to the high-speed transaction completing.

22. The system of claim 21, wherein the USBCI is further configured to:
prior to initiating the high-speed transaction, store the data received from the USB host via the non high-speed transaction; or
prior to initiating the high-speed transaction, store the data received from the USB host via the non high-speed transaction, transmit to the USB device via the high-speed transaction at least a first portion of the stored data received from the USB host via the non high-speed transaction.

23. The system of claim 21, wherein the USBCI is further configured to receive data from the USB device via the high-speed transaction, and store the data received from the USB device via the high-speed transaction.

24. The system of claim 23, wherein the USBCI is further configured to transmit at least a portion of the stored data received from the USB device to the USB host via the non high-speed transaction via the high-speed transaction.

25. The system of claim 21, wherein the USBCI is configured to detect a specified operating speed of the non high-speed USB host, and to indicate the operating speed of the non high-speed USB host to the high-speed USB device.
